(19) United States
(12) Patent Application Publication
(10) Pub. No.: US 2008/0156293 A1
(43) Pub. Date: Jul. 3, 2008

(54) Method for operating a diesel engine in a homogeneous charge compression ignition combustion mode under idle and light-load operating conditions

(76) Inventor: Yiqun Huang, San Antonio, TX (US)

Correspondence Address: Ted D. Lee;Gunn & Lee, P.C., Suite 1500, 700 N. St. Mary's St., San Antonio, TX, 78205, US

(21) Appl. No.: 11/648,044

(22) Filed: Dec. 29, 2006

(51) Int. Cl. F02B 3/06

(52) U.S. Cl. 123/299

(57) ABSTRACT

Intake air is restricted to provide an intake manifold pressure that is below the pressure of the ambient atmosphere. Fuel is injected into each combustion chamber at a position of between 15° and 45° BTDC to achieve HCCI combustion under idle and light load operating conditions.

### BACKGROUND OF THE INVENTION

1. Technical Field

This invention relates generally to a method for operating a diesel engine, and more particularly to such a method for operating a diesel engine under idle and light-load operating conditions.

2. Background Art

Conventional diesel combustion produces relatively high concentrations of various oxides of nitrogen (NOₓ) and particulate matter (PM), because the diffusion flame, i.e., a long gas flame that radiates uniformly over its length and precipitates free-carbon uniformly, results in fuel droplets dispersed in the fuel/air (F/A) charge burning stoichiometrically. The U.S. Environmental Protection Agencies (EPA) has set very stringent emissions standards for diesel engines. Exhaust gas treatment devices have been, and are currently being, developed to reduce undesirable emissions from diesel engines. At the present time, lean NOₓ traps (LNTs) are the most likely exhaust treatment devices for the control of NOₓ emissions and diesel particulate filters (DPFs) are a near certainty for PM control.

However, exhaust gas treatment devices in general, and lean NOₓ traps and diesel particulate filters in particular, are not effective unless they are heated to a predefined operating, or activation, temperature. During idle and low load operation, the exhaust gas temperature provided during conventional diesel combustion mode operation is often insufficient to maintain downstream exhaust gas after-treatment devices at their required operating temperature.

A method of combustion identified as Homogenous Charge Compression Ignition (HCCI), has the potential to dramatically reduce NOₓ and PM emissions. Homogenous Charge Compression Ignition (HCCI) is a mode of combustion in which a premixed fuel/air charge is elevated in temperature during the compression stroke until the thermal dynamic conditions of the premixed charge are satisfactory for the initiation of combustion. HCCI combustion occurs when a lean homogenous mixture of diesel fuel and air begins combustion toward the end of the engine compression stroke. Heretofore, a homogenous mixture of fuel and air was created using a conventional automotive-style port fuel injector or by early, i.e., near-bottom dead center (BDC), direct in-cylinder fuel injection. Consequently, direct-cylinder fuel injection for HCCI operation has required a specifically designed fuel injector which produces a very narrow-angle spray pattern, i.e., at or less than 60°, to prevent liquid fuel integument on exposed combustion chamber walls.

U.S. Pat. No. 4,993,643, granted Feb. 19, 1991 to Michael M. Schaechter, et al., for a FUEL INJECTOR WITH A VARIABLE FUEL SPRAY SHAPE OR PATTERN, describes a fuel injector adapted to provide varying shapes of fuel spray as a function of different engine operating conditions. However, this specific multi-mode fuel injector does not provide sufficient dispersion of the fuel within the combustion chamber, a condition desirable for conventional diesel combustion mode operation. A fuel injector specifically designed for homogenous charge compression ignition combustion is described in U.S. Pat. No. 6,564,772, granted May 20, 2003, to Tsu Pin Schyu et al. for an INJECTOR TIP FOR INTERNAL COMBUSTION ENGINE. However, the Schyu et al. injector tip is only applicable to narrow spray angle fuel injection useful in the very early injection of fuel and does not provide sufficient dispersion of the fuel for conventional diesel operation The present invention is specifically directed to overcoming the above-described problem associated with exhaust gas temperatures that are too low to maintain downstream exhaust gas aftertreatment devices at their respective required operating temperatures during idle and part load operation in a conventional diesel combustion mode and prevent liquid fuel impingement on the combustion chamber surfaces during HCCI combustion mode operation.

It is desirable to have a method for selectively operating a diesel engine in a conventional diesel mode during medium and high load operation, and in an HCCI combustion mode during idle and low load operation that minimizes the deposition of fuel on combustion chamber surfaces during operation in the HCCI combustion mode. It is also desirable to have such a method that does not compromise the desirable characteristics of conventional diesel combustion mode operation.

### SUMMARY OF THE INVENTION

In accordance with one aspect of the present invention, a method for operating a diesel engine in a homogenous charge compression ignition combustion mode under idle and light load operating conditions includes providing an intake manifold pressure of less than 100 kPa-absolute and injecting fuel into each combustion chamber of the engine when a piston is at a position of between about 15° and 45° Below Top Dead Center (BTDC) during a compression stroke prior to combustion.

Other features of the method for operating a diesel engine in an homogenous charge compression ignition combustion mode under idle and light load operating conditions, in accordance with the present invention, includes injecting fuel at a spray angle that is less than an angle at which fuel is injected for conventional diesel combustion and greater than an angle at which fuel impingement on the combustion chamber wall is avoided when the piston is positioned at 45° BTDC.

Other features of the method for operating a diesel engine, in accordance with the present invention, include at least partially closing an intake throttle valve to restrict the flow of intake air.

### BRIEF DESCRIPTION OF THE DRAWINGS

A more complete understanding of the method for operating a diesel engine in a homogenous compression ignition combustion mode under idle and light load operating conditions, in accordance with the present invention, may be had by reference to the following detailed description when taken in conjunction with the accompanying drawings, wherein:

FIG. 1 is a schematic diagram of the effect of restricting intake manifold pressure less than that of the ambient atmosphere on NOₓ and PM emissions and exhaust manifold temperature;

FIG. 2 is a schematic diagram of an engine system adapted to carry out the method for operating a diesel engine in an homogenous charge compression ignition combustion mode under idle and light load operating conditions in accordance with the present invention;

FIG. 3 is a schematic diagram of a conventional diesel engine combustion chamber with piston at 45° BDTC, illustrating the slightly modified fuel spray angle used in carrying out the present invention; and

FIG. 4 is a schematic diagram of a conventional diesel engine combustion chamber with the piston at Top Dead Center (TDC), illustrating the slightly modified fuel spray angle used in carrying out the present invention.

### DETAILED DESCRIPTION OF THE INVENTION

Several methods have been used heretofore to form a homogenous fuel/air mixture with low volatility fuel, such as diesel fuel. For example, high temperature exhaust gas recirculation or heating of the intake air charge have been proposed to promote evaporation of the low volatility fuel. Also, multiple injections having a narrow spray angle of about 60° or less, beginning during the intake stroke or early in the compression stroke, have been proposed for use in HCCI combustion operations to increase fuel penetration distance and minimize the amount of liquid fuel deposited on combustion chamber surfaces.

In a preferred embodiment of the present invention, throttling of the intake air is used to provide an intake manifold pressure that is below the pressure of the ambient atmosphere, i.e., less than 100 kPa-absolute. The term “intake manifold pressure” as used herein and in the claims, means the pressure of the intake air charge at the intake ports of the combustion chambers in the engine.

It is well recognized that turbocharging does not a significant effect on intake manifold pressure when operating under light and low load operating conditions. Therefore, intake air throttling can be used in turbocharged engines to reduce intake manifold pressure to a very low level, for example about 50-55 kPA-absolute during idle and low load operation of the engine. In carrying out the present invention, exhaust gas recirculation is generally not used when operating under idle and low load conditions during HCCI combustion mode operation so that the desired very low intake manifold pressure can be more easily implemented and controlled.

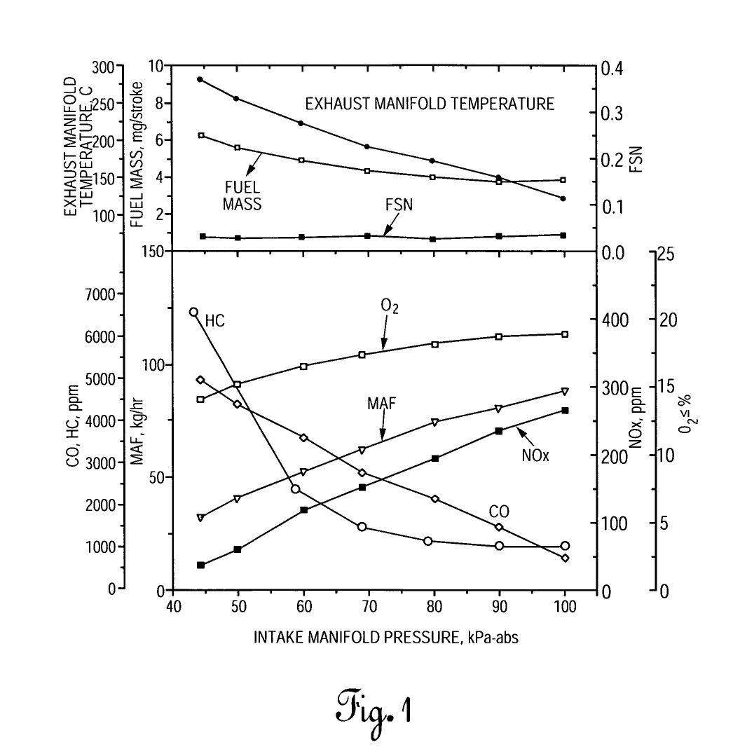

With reference to FIG. 1, it can be seen that as the intake manifold pressure is reduced below atmosphere (below 100 kPa-absolute) NOₓ emissions are significantly reduced and particulate matter (PM), as represented by the FSN or Filter Smoke Number, is essentially unaffected. At the same time, the mass air flow (MAF) and oxygen (O2) are reduced and the fuel mass is slightly increased. Accordingly, the increased fuel/air ratio provides a substantial increase in exhaust manifold temperature, thereby enabling downstream exhaust gas aftertreatment devices to be maintained at their respective desired operating temperature. Also, hydrocarbon (HC) and carbon monoxide (CO) generation significantly increases as manifold intake pressure decreases. The increased HC and CO levels beneficially maintain the exothermic reaction in exhaust system catalyst-based aftertreatment devices during idle and light load operation and thereby sustain the temperature in such devices above their respective activation temperature.

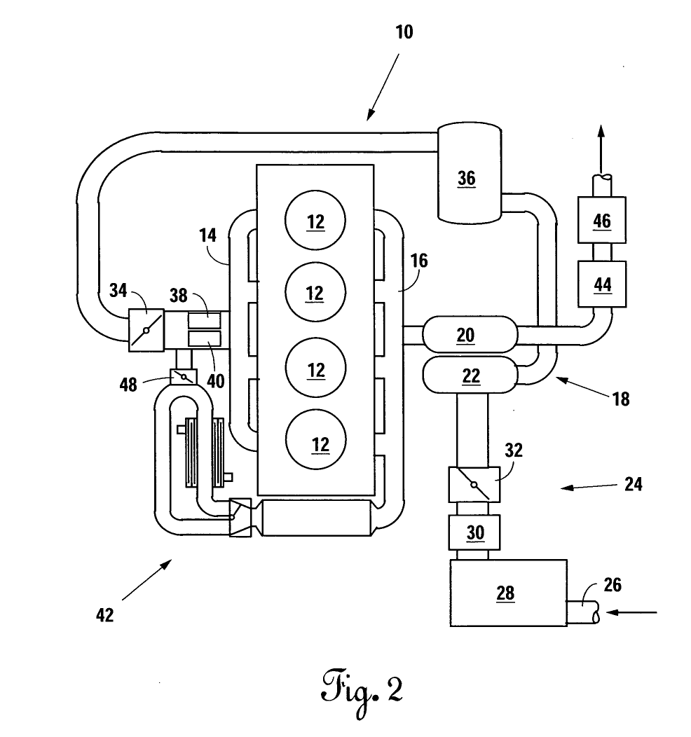

A diesel engine suitable for illustrating the preferred embodiment of the method for operating a diesel engine in a homogenous charge compression ignition combustion mode under idle and light load operating conditions, in accordance with the present invention, is generally identified by the reference number 10 in FIG. 2. The engine 10 has a plurality of cylinders, or compression chambers, 12, each of which of which is in controlled fluid communication by way of intake and exhaust valves (not shown) respectively with an intake manifold 14 and an exhaust manifold 16. The engine 10 also has a conventional variable geometry turbocharger (VGT) 18. A turbine section 20 of the turbocharger 18 is in direct fluid communication with the exhaust manifold 16 and has a variable throat area which can be closed to a minimum flow position at which exhaust flow through the turbine section is severely limited. Alternatively, a waste gate can provide a flow of exhaust gas around the turbine section 20. A compressor section 22 of the turbocharger 18 is in fluid communication with the intake manifold 14 of the engine 10.

The engine 10 also has an intake air, or combustion charge, system that is generally indicated by the reference number 24 in FIG. 2. The intake air system 24 includes an intake air duct 26 in fluid communication with ambient air inducted through an air filter 28. An intake air mass air flow (MAF) sensor 30 and an optional low pressure intake air throttle valve 32 are positioned between the air filter 28 and an intake port of the compressor section 22 of the turbocharger 18. The intake air system 24 further includes a high pressure intake air throttle valve 34 positioned in close proximity to the intake manifold 14 and an intercooler 36 adapted to cool the compressed intake air charge. The intercooler 36 is interposed between a discharge port of compressor section 22 and the high pressure intake air throttle valve 34. An intake manifold air pressure (MAP) sensor 38 and an intake manifold air temperature (MAT) sensor 40 are positioned adjacent to the intake manifold 14.

In the illustrated representative engine system, the engine 10 has exhaust gas aftertreatment devices such as an oxidation catalyst 44 and a continuously regenerable diesel particulate filter and lean NOₓ trap (cDPF/LNT) 46 positioned between a discharge port of the turbine stage 20 of the turbocharger 18 and the ambient environment. The aftertreatment devices 44, 46 are catalytic-based converters or traps that reduce harmful emissions in the exhaust discharge from the engine 10 and require that the catalytic surfaces, or beds, within the devices be heated to a temperature within a predefined operating range in order to function for their intended purposes. Importantly, the present invention is directed to providing an exhaust gas sufficient to maintain the exhaust aftertreatment devices 44, 46 at their respective predefined activation temperatures during idle and low load engine operating conditions.

The engine 10 has a high pressure loop exhaust gas recirculation (EGR) system that is generally indicated by the reference number 42. The high pressure EGR system 42 is arranged to recirculate controlled amounts of exhaust gas from the exhaust manifold 16 back to the intake manifold 14. An exhaust gas recirculation control valve 44, mounted in close proximity to the intake air manifold 14, controls the flow of recirculated exhaust gas through the high pressure loop EGR system 42.

In carrying out the present invention, the EGR control valve 48 may be closed during homogenous charge compression ignition combustion mode operation under idle and light load conditions to more easily maintain a sub-atmospheric intake manifold pressure.

Turning now to the method for operating a diesel engine in a homogenous charge compression engine combustion mode under idle and light load operating conditions, an intake manifold pressure less than 100 kPa-absolute is provided by throttling the intake air. In the above-described diesel engine arrangement, the intake air may be throttled by partially closing the low pressure intake air throttle valve 32, the high pressure intake air throttle valve 34, or both. The effect of restricting the intake air charge to the combustion chambers 12 was described above with reference to FIG. 1. Importantly, as intake air is significantly throttled to provide a very low intake manifold pressure, for example about 50 kPa-absolute, the exhaust gas temperature is significantly increased, thereby providing the downstream aftertreatment devices 44, 46 with an exhaust gas flow having a temperature sufficient to maintain the catalytic bed of the aftertreatment devices 44, 46 at their respective operating temperatures.

If the diesel engine has a variable valve actuation (VVA) system, the intake valves may alternatively be controlled to restrict the intake air flow into the combustion chambers 12. Also, if it is desired to further increase the temperature of the exhaust gas directed to the downstream aftertreatment devices 44, 46, a small amount of exhaust gas may be recirculated through the high pressure exhaust gas recirculation system 42 by regulating the EGR control valve 48. If the engine has a low pressure EGR system, instead of the high pressure EGR system illustrated in FIG. 2, controlled amounts of EGR may also be reintroduced into the intake manifold 14 by appropriate control of a low pressure EGR flow control valve.

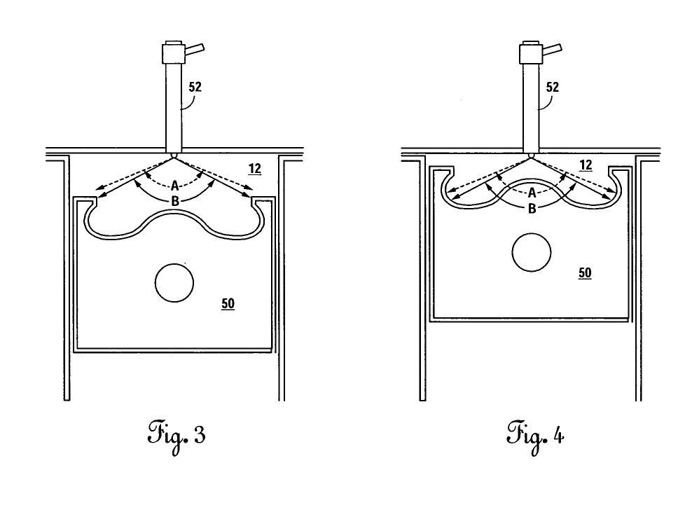

The lower cylinder pressure resulting from significantly restricting the intake air flow advantageously increases the fuel vaporization rate by lowering the fuel boiling point and promotes stable combustion. Accordingly, HCCI combustion can be achieved by injecting conventional liquid diesel fuel nearer to the top of the compression stroke, for example about 45° BTBC instead of the heretofore required injection near the bottom of the intake stroke or at the beginning of the compression stroke, i.e., about 60° to 100° BTBC. An important advantage of being able to achieve HCCI combustion by later fuel injection closer to BTDC is that the spray angle represented by the dotted lines A in FIGS. 3 and 4, illustrating a conventional diesel injector spray angle, only needs to be modified slightly to an angle B, shown by solid lines, to prevent fuel impingement on cylinder walls when the piston 50 is at 45° BTDC as shown in FIG. 3 and at BTDC as illustrated in FIG. 4. Thus, in carrying out the present invention, a conventional diesel fuel injector 52, having a slightly narrowed fuel spray angle can be used for both HCCI combustion and conventional diesel combustion, thereby eliminating the need for separate fuel injectors or troublesome variable angle injectors with associated control circuitry for different combustions modes.

If intake manifold pressure is sufficiently reduced, it is even possible to achieve HCCI combustion with injection as late as 15° BTDC. Therefore, in carrying out the present invention, fuel is typically injected into each combustion chamber 12 when the piston 52 is at a position between about 15 degrees and 45° BTDC during a compression stroke prior to combustion.

Transition from standard diesel combustion to HCCI combustion is easily achieved as a result of the slightly modified fuel injector spray angle. When operating in the standard diesel combustion mode, injection timing can be advanced simultaneously with reduction of intake manifold pressure to a point where the low intake manifold pressure, the high residual temperature and high residual fraction conditions improve fuel evaporation and air mixing to achieve HCCI combustion. Also, higher in-cylinder residual temperature further promotes homogeneous mixing of the fuel air charge. By reducing intake charge pressure, along with higher exhaust gas temperatures, higher CO and HC are generated during HCCI combustion and provide the exothermic conditions desirable for operation of the downstream aftertreatment devices. Very low excess air is produced, thereby increasing exhaust and catalyst temperatures. Exhaust emissions flow rate is reduced by significantly reducing intake charge mass. Soot emission is reduced as a result of enhanced fuel vaporization and fuel air mixing.

Also, it has been found that stable combustion under extremely low intake charge pressures can be maintained by advancing a first injection event to generate a premixed charge dominated fuel mixture when operating in the standard diesel combustion mode.

Although the present invention is described in terms of an illustrated preferred embodiment with reference to a specific engine configuration, those skilled in the art will recognize that the implementation of the method for operating a diesel engine in a homogenous charge compression ignition combustion mode under idle and light load operating conditions can be modified. As discussed above, the engine configuration may vary from the engine used to illustrate the preferred embodiment of the present invention. For example, the engine may be equipped with a low pressure exhaust gas recirculation system, or the engine may be equipped with a variable valve actuation system which can be used to restrict intake charge pressure into the combustion chambers of the engine. Such applications of a method embodying the present invention are intended to fall within the scope of the following claims. Other aspects, features and advantages of the present invention may be obtained from a study of this disclosure and the drawings, along with the appended claims.

1. A method for operating a diesel engine in a homogeneous charge compression ignition combustion mode under idle and light load operating conditions, comprising;
providing an intake manifold pressure of less than 100 kpa-absolute; and,
injecting liquid fuel into each combustion chamber when a piston reciprocally disposed therein is at a position between about 15° and 45° BTDC during a compression stroke prior to combustion; and,
maintaining said intake manifold pressure at a pressure less than 100 kPa absolute sufficient to completely vaporize said injected liquid fuel prior to combustion of the fuel.

2. The method for operating a diesel engine, as set forth in claim 1, wherein said diesel engine has a single fuel injector associated with each combustion chamber and said injecting fuel into each combustion chamber includes injecting liquid fuel at a spray angle that is less than an angle at which fuel is injected for convention diesel combustion and greater than an angle at which fuel impingement on the combustion chamber wall is avoided when said piston is positioned at 45° BTDC.

3. The method for operating a diesel engine, as set forth in claim 1, wherein said engine has an intake air throttle valve disposed in an intake air duct in communication with an intake manifold of the engine, and said providing an intake manifold pressure of less than 100 kpa-absolute includes moving said throttle valve to at least a partially closed position.

4. (canceled)

5. The method for operating a diesel engine, as set forth in claim 1, wherein said engine has an exhaust gas recirculation system and said providing an intake manifold pressure of less than 100 kPa-absolute includes closing an exhaust gas recirculation control valve associated with said exhaust gas recirculation system and preventing the recirculation of exhaust gas to the intake manifold of the engine.

6. The method for operating a diesel engine, as set forth in claim 1, wherein said engine includes an exhaust gas system having at least one exhaust gas aftertreatment device disposed therein and having a predetermined operating temperature range requirement for efficient operation thereof, and said providing an intake manifold pressure of less than 100 kPa-absolute and injecting liquid fuel into each combustion chamber when a piston reciprocally disposed therein is at a position between about 15° and 45° BTDC includes controlling said intake manifold pressure and said liquid fuel injection timing to provide an exhaust gas temperature sufficient to maintain said exhaust gas aftertreatment device at said operating temperature range during operation of the engine in said idle and low load conditions.

7. The method for operating a diesel engine, as set forth in claim 1, wherein said engine includes an exhaust gas system having at least one catalyst-based exhaust gas aftertreatment device disposed therein and having a predetermined operating temperature range requirement for efficient operation thereof, and said providing an intake manifold pressure of less than 100 kPa-absolute and injecting liquid fuel into each combustion chamber when a piston reciprocally disposed therein is at a position between about 15° and 45° BTDC includes controlling said intake manifold pressure and said liquid fuel injection to provide an intake manifold pressure sufficient to increase HC and CO generation to an amount sufficient to maintain the exothermic reaction in said at least catalyst-based exhaust gas aftertreatment device during idle and light load operation and thereby sustain the temperature in such devices above a respective activation temperature.

8. The method for operating a diesel engine, as set forth in claim 1, wherein said engine includes a turbocharger having a compressor stage with an intake port and a discharge port and a low pressure intake air throttle valve disposed in an intake air duct communicating with the intake port of said compressor stage and said providing an intake manifold pressure of less than 100 kpa-absolute includes moving said low pressure throttle valve to at least a partially closed position.

9. The method for operating a diesel engine, as set forth in claim 1, wherein said engine includes a turbocharger having a compressor stage with an intake port and a discharge port and a high pressure intake air throttle valve disposed in an intake air duct communicating with the discharge port of said compressor stage and an intake manifold of the engine and said providing an intake manifold pressure of less than 100 kpa-absolute includes moving said high pressure throttle valve to at least a partially closed position.

10. A method for operating a diesel engine in a homogeneous charge compression ignition combustion mode under idle and light load operating conditions, said engine having a variable valve actuation system adapted to control the opening and closing of at least the intake valves associated with respective combustion chambers, said method comprising:
injecting liquid fuel into each combustion chamber of the engine when a piston reciprocally disposed therein is at a position between about 15 E and 45 E BTDC during a compression stroke prior to combustion of said injected fuel; and,
simultaneously controlling the closing of said intake valves to restrict intake air flow into each combustion chamber and provide an in-cylinder pressure of less than 100 kpa-absolute sufficient to completely vaporize the liquid injected fuel prior to combustion of the fuel.

11. The method for controlling a diesel engine, as set forth in claim 10, wherein said engine has an intake air throttle valve disposed in communication with an intake manifold of the engine and said method includes moving said throttle valve to at least a partially closed position.
